(19) United States
(12) Patent Application Publication
(10) Pub. No.: US 2023/0413207 A1
(43) Pub. Date: Dec. 21, 2023

(54) METHODS AND APPARATUSES FOR HANDLING TIME ALIGNMENT FOR A SMALL DATA TRANSMISSION PROCEDURE

(71) Applicant: Lenovo (Beijing) Limited, Beijing (CN)

(72) Inventors: Ran Yue, Beijing (CN); Haiming Wang, Beijing (CN); Lianhai Wu, Beijing (CN); Jie Shi, Beijing (CN); Jing Han, Beijing (CN)

(73) Assignee: Lenovo (Beijing) Limited, Beijing (CN)

(21) Appl. No.: 18/248,687

(22) PCT Filed: Oct. 12, 2020
(86) PCT No.: PCT/CN2020/120478

§ 371 Date: Apr. 11, 2023

(51) Int. Cl. H04W 56/00; H04W 74/08

(52) U.S. Cl. CPC H04W 56/0045; H04W 74/0833

(57) ABSTRACT

Embodiments of the present disclosure relate to methods and apparatuses for handling time alignment for a small data transmission (SDT) procedure of a user equipment (UE). According to an embodiment of the present disclosure, a method includes: receiving, by a user equipment (UE), indication information, wherein the indication information indicates that a base station (BS) supports a small data transmission (SDT) procedure, and wherein the UE is capable to perform the SDT procedure; and receiving configuration information regarding a time alignment timer (TAT) for the SDT procedure.

### TECHNICAL FIELD

The present application generally relates to wireless communication technology, and especially to methods and apparatuses for handling time alignment (TA) for a small data transmission (SDT) procedure of a user equipment (UE).

### BACKGROUND

In 3GPP (3rd Generation Partnership Project) 5G system, a small data transmission is introduced for several use cases. For example, according to an agreement of 3GPP TSG RAN Meeting #86, a small data transmission can be used for smartphone applications including traffic from instant messaging services or used for non-smartphone applications including traffic from wearables. A small data transmission may also be named as a small data packet or the like. In general, any device that has intermittent small data transmissions in radio resource control (RRC) inactive state or RRC idle state will benefit from enabling small data transmission in RRC inactive state (i.e., RRC INACTIVE state) or RRC idle state (i.e., RRC IDLE state).

3GPP 5G networks are expected to increase network throughput, coverage, and robustness and reduce latency and power consumption. With the development of 3GPP 5G networks, various aspects need to be studied and developed to perfect the 5G technology.

### SUMMARY

One object of embodiments of the present disclosure is to provide novel mechanisms for handling time alignment for a SDT procedure of a UE.

Some embodiments of the present application provide a method, which may be performed by a UE. The method includes: receiving, by the UE, indication information, wherein the indication information indicates that a base station (BS) supports a SDT procedure, and wherein the UE is capable to perform the SDT procedure; and receiving configuration information regarding a time alignment timer (TAT) for the SDT procedure.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE.

Some embodiments of the present application provide a method, which may be performed by a network or a BS. The method includes: transmitting indication information, wherein the indication information indicates that a BS supports a SDT procedure; and transmitting configuration information regarding a TAT for the SDT procedure.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network or a BS.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application;

FIG. 2 is a contention-based random access (CBRA) procedure with 4-step random access (RA) type according to some embodiments of the present application;

FIG. 3 is a CBRA procedure with 2-step RA type according to some embodiments of the present application;

FIG. 4 is a flow diagram illustrating a method for receiving configuration information regarding a TAT for a SDT procedure according to some embodiments of the present application;

FIG. 5 is a flow diagram illustrating a method for transmitting configuration information regarding a TAT for a SDT procedure according to some embodiments of the present application; and

FIG. 6 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8, B5G, 6G, and so on. It is contemplated that along with developments of network architectures and new service scenarios, all embodiments in the present application are also applicable to similar technical problems; and moreover, the terminologies recited in the present application may change, which should not affect the principle of the present application.

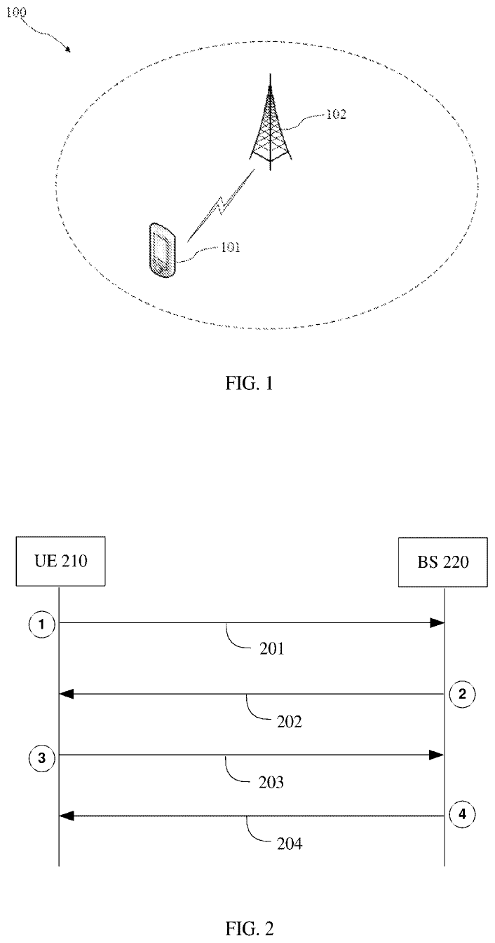

FIG. 1 illustrates a wireless communication system according to some embodiments of the present application.

Referring to FIG. 1, the wireless communication system 100 may include a UE 101 and a BS 102. Although a specific number of UE 101 and BS 102 are depicted in FIG. 1, it is contemplated that additional UEs 101 and BS s 102 may be available in the wireless communication system 100.

A BS 102 may be distributed over a geographic region, and may communicate with a core network (CN) node. In some embodiments of the present application, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally part of a radio access network that may include one or more controllers communicably coupled to one or more corresponding BS(s) 102.

A UE 101 may directly communicate with the BS 102 via uplink communication signals. The UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present application, a UE 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, industrial Internet-of-Things (IIoT) devices, or the like.

According to some embodiments of the present application, a UE 101 may include, for example, but is not limited to, a portable wireless communication device, a smart phone, a cellular telephone, a flip phone, a device having a subscriber identity module, a personal computer, a selective call receiver, or any other device that is capable of sending and receiving communication signals on a wireless network.

In addition, in some embodiments of the present application, a UE 101 may include, for example, but is not limited to, wearable devices, such as smart watches, fitness bands, optical head-mounted displays, or the like.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a LTE network, a 3GPP-based network, a 3GPP 5G network, a satellite communications network, a high altitude platform network, and/or other communications networks.

In some embodiments of the present application, the wireless communication system 100 is compatible with the 5G new radio of the 3GPP protocol, wherein BS s 102 transmit data using an OFDM modulation scheme on the DL and UE 101 transmit data on the UL using a single-carrier frequency division multiple access (SC-FDMA) or OFDM scheme. More generally, however, the wireless communication system 100 may implement some other open or proprietary communication protocols, for example, WiMAX, WiFi, among other protocols.

In some embodiments of the present application, the BS 102 may communicate using other communication protocols, such as the IEEE 802.11 family of wireless communication protocols. Further, in some embodiments of the present application, the BS 102 may communicate over licensed spectrums, whereas in other embodiments the BS 102 may communicate over unlicensed spectrums. The present application is not intended to be limited to the implementation of any particular wireless communication system architecture or protocol. In yet some embodiments of present application, the BS 102 may communicate with UE 101 using the 3GPP 5G protocols.

FIG. 2 is a contention-based random access (CBRA) procedure with 4-step random access (RA) type according to some embodiments of the present application. The embodiments of FIG. 2 show a procedure of a UE (e.g., UE 210) communicating with a base station (e.g., BS 220). In some examples, UE 210 may function as UE 101 in FIG. 1. BS 220 may function as BS 102 in FIG. 1.

In the embodiments of FIG. 2, four steps of the CBRA procedure are:
(1) In operation 201, UE 210 transmits Random Access Preamble via message 1 (i.e., MSG1, MSG.1, Msg1, Msg.1, or the like) to BS 220.
(2) In operation 202, UE 210 receives Random Access Response via message 2 (i.e., MSG2, MSG.2, Msg2, Msg.2, or the like) from BS 220.
(3) In operation 203, UE 210 transmits message 3 (i.e., MSG3, MSG.3, Msg3, Msg.3, or the like) to the serving cell of BS 220:
For initial access procedure:
   UE 210 conveys the RRC Connection Request which is generated by the RRC layer and transmitted via a common control channel (CCCH).
For RRC Connection Re-establishment procedure:
   UE 210 conveys the RRC Connection Re-establishment Request which is generated by the RRC layer and transmitted via CCCH.
In the procedure to resume the RRC connection:
   UE 210 conveys the RRC Connection Resume Request which is generated by the RRC layer and transmitted via CCCH.
   UE 210 conveys a Resume identify (ID) to resume the RRC connection state.
   A RRC connection state may also be named as RRC CONNECTION state, RRC_CONNECTION state, RRC connected state, RRC_CONNECTED state, RRC_Connected state, or the like.
(4) In operation 204, UE 210 receives message 4 (i.e., MSG4, MSG.4, Msg4, Msg.4, or the like) from BS 220 for a contention resolution purpose.

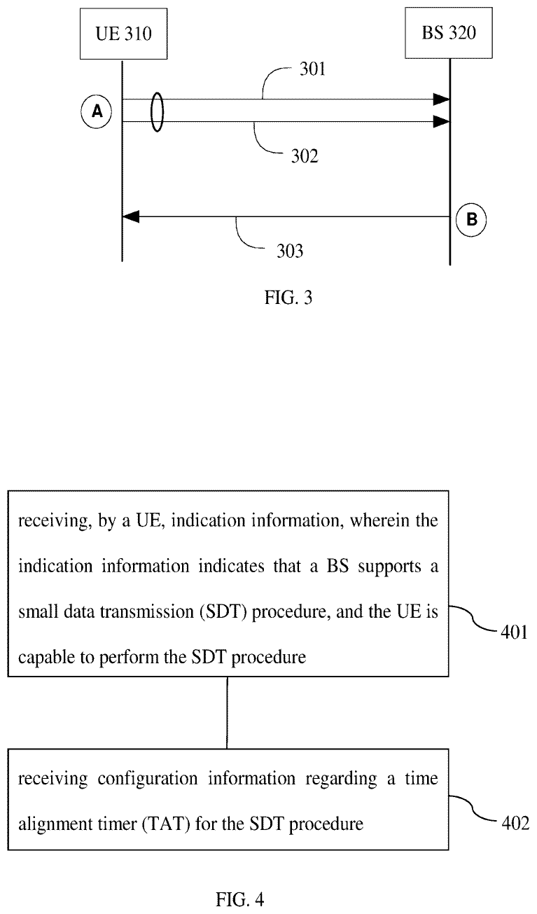

FIG. 3 is a CBRA procedure with 2-step RA type according to some embodiments of the present application. The embodiments of FIG. 3 show a procedure of a UE (e.g., UE 310) communicating with a base station (e.g., BS 320). In some examples, UE 310 may function as UE 101 in FIG. 1. BS 320 may function as BS 102 in FIG. 1.

In the embodiments of FIG. 3, message A (i.e., MSGA, MSG.A, MsgA, Msg.A, or the like) of the 2-step RA type includes a preamble on Physical Random Access Channel (PRACH) and a payload on a physical uplink shared channel (PUSCH).

After MSGA is transmitted to BS 320 in operations 301 and 302, UE 310 monitors a response from BS 320 (i.e., a network response). For CFRA, a dedicated preamble and a PUSCH resource are configured for MSGA transmission, and upon receiving the response from BS 320, UE 310 ends the RA procedure. For CBRA, if a contention resolution is successful upon receiving the response from BS 320, UE 310 ends the RA procedure.

In operation 303, if a fallback indication is received in message B (i.e., MSGB, MSG.B, MsgB, Msg.B, or the like) from BS 320, UE 310 performs MSG3 transmission using a UL grant which is scheduled in the fallback indication and monitors a contention resolution. If the contention resolution is not successful after MSG3 (re)transmission(s), UE 310 goes back to MSGA transmission.

Generally, in a narrow band internet of things (NB-IoT) system or an enhance machine type communication (eMTC) early data transmission (EDT) system, packet segmentation is not supported for the EDT procedure. Therefore, there is not a TAT introduced to an EDT procedure, since the data packet in the EDT procedure is one shot transmission. In some cases, there may be potential multiple UL and DL packets following a UL SDT procedure without transitioning a UE to RRC_CONNECTED state, which means that the UE should continue the UL or DL transmission with a longer time and a time alignment (TA) is expected to be valid for such longer time. Therefore, it is necessary to optimize the procedure associated with a TAT for a SDT procedure, especially in the potential use case of SDT applied for RedCap. However, an issue regarding how to configure a TAT for a SDT procedure has not been addressed. The TA is valid may also be named as that the TA is maintained. The TA is invalid may also be named as that the TA is not maintained. A TAT for a SDT procedure may also be named as a SDT TAT or a TAT for SDT or the like.

Basically, there may be following two scenarios:
Scenario a): Some data radio bearers (DRBs) are configured to be transmitted by configured grant (CG) based SDT procedure (for example, CG type1 based SDT procedure), and some DRBs are configured to be transmitted by random access channel (RACH) based SDT procedure.
When the SDT TA is valid and the TAT is running for the CG type 1 based SDT procedure, a RACH based SDT procedure can be initialized as well. In this scenario, a timing advance command (TAC) will be received during the RACH based SDT procedure. After the contention resolution, the UE could be still in the RRC_INACTIVE state. However, an issue regarding how to handle a TAC and a TAT during the RACH based SDT has not been addressed yet.
Scenario b): When a SDT TA is valid and a SDT TAT is running for the RACH based SDT procedure and/or the CG based SDT procedure (for example, CG type1 based SDT procedure), a legacy RACH procedure may be initialized, for example, for radio access network based notification area update (RNAU).
In such scenario, a TAC will be received in Msg2 or MsgB. After the contention resolution, the UE could be still in the RRC_INACTIVE state. However, an issue regarding how to handle the TAC received in Msg2 when the SDT TAT is running has not been addressed yet.

In general, the TAT being running can be considered as TA being valid, when the UE is in the RRC_CONNECTED state. While a TAC received during a contention procedure based a legacy RACH procedure or a RACH based SDT procedure may be not for the UE, since the contention procedure has not been resolved. Therefore, the TAC may be not credible for the UE. Since packet segmentation is not supported for the EDT procedure in legacy NB-IOT/eMTC EDT, the above two scenarios need to be addressed.

Embodiments of the present application provide a mechanism for handling TA for a SDT procedure of a UE in 3GPP 5G NR system or the like to solve any of the above issues. More details will be illustrated in the following text in combination with the appended drawings.

In some embodiments, one or more larger TAT values are added to a parameter associated with a TAT (e.g., timeAlignmentTimerCommon or timeAlignmentTimer). The corresponding behaviours may be defined when the one or more larger TAT value is applied to a SDT procedure. For example, when a larger TAT value is transmitted in a system broadcast message, the TAT is only applied to the SDT procedure. When a larger TAT value is transmitted in a RRC message or RRC signaling, a UE may consider the TAT as not expired and may started or restarted the TAT once the UE transits from RRC_CONNECTED state to RRC_IDLE state or the UE transits from RRC_CONNECTED state to RRC_INACTIVE state.

In some further embodiments, a new TAT during a RACH based SDT procedure is configured in a message of Msg2, MsgB, or Msg4. For example, a TAT for a RACH based SDT procedure is configured after UL assistant information indicates that there are multiple UL or DL packets following the RACH based SDT procedure. In this case, the TAT for the RACH based SDT procedure is UE-specific. That is, different UEs may have different TATs for a RACH based SDT procedure.

In some other embodiments, a TAT for a SDT procedure is configured in a system broadcast information. In an example, the SDT TAT is explicitly configured in system information block 1 (SIB1). In another example, when a network or a BS indicates supporting a SDT procedure, a default or pre-configured TAT for a SDT procedure (i.e., a SDT TAT) will be used. In this case, the SDT TAT is cell-specific. That is, different UEs in the same cell have the same SDT TAT.

Some embodiments assume that there are more than one criteria (not only TAT running) to decide whether the SDT TA is valid refer to the agreements of a preconfigured uplink resource (PUR). For example, in a case that a SDT TAT is running but reference signal received power (RSRP) change is higher than a threshold at the same time, TA is deemed as not valid. Therefore, the TA may be valid or not valid, when a SDT TAT is running.

In some embodiments, when a TAC is received in a random access response message (e.g., Msg2) for which procedure the contention resolution has not been successfully completed, a UE stores the TA value received in Msg2 and applies the existed SDT TA value for the following RACH UL transmissions if the TA for SDT is valid. Once the contention resolution is considered as successful, the UE sets the stored value to the TA value, restarts the TAT, and re-initializes all other configured TA related counter or timer.

In some further embodiments, when a TAC is received in a random access response message (e.g., Msg2) for which procedure the contention resolution has not been successfully completed, a UE applies the TAC, and starts or restarts the SDT-timeAlignmentTimer if TA is not valid. Once the contention resolution is considered as not successful, the TA for SDT should be considered as invalid. The UE stops the SDT-timeAlignmentTimer and all the other configured TA related counter or timer. Once the contention resolution is considered as successful, the TA for SDT should be considered as valid.

FIG. 4 is a flow diagram illustrating a method for receiving configuration information regarding a TAT for a SDT procedure according to some embodiments of the present application.

The method illustrated in FIG. 4 may be implemented by a UE (e.g., UE 101, UE 210, or UE 310 as shown and illustrated in any of FIGS. 1-3). Although described with respect to a UE, it should be understood that other devices may be configured to perform a method similar to that of FIG. 4.

As shown in FIG. 4, in operation 401, a UE receives indication information, wherein the indication information indicates that a BS supports a SDT procedure. The UE is capable to perform the SDT procedure. For example, the SDT procedure is at least one of: a RACH based SDT procedure; and a CG based SDT procedure (e.g., CG type1 based SDT procedure).

In an embodiment, the TAT for the SDT procedure is used only for the RACH based SDT procedure. In a further embodiment, the TAT for the SDT procedure is used only for the CG based SDT procedure. In another embodiment, the TAT for the SDT procedure is used for a combination of the RACH based SDT procedure and the CG based SDT procedure.

In some embodiments, the UE is configured with at least one of: one or more HARQ buffers for a CG based SDT procedure; and a HARQ buffer for a RACH based SDT procedure. For example, besides one or more HARQ buffers for a CG type 1 based SDT procedure, a separate Msg3 or MsgA HARQ buffer for RACH based SDT procedure is configured to the UE.

In an embodiment, if the UE is configured to support both the RACH based SDT procedure and the CG based SDT procedure and if a medium access control (MAC) packet data unit (PDU) in the one or more HARQ buffers for the CG based SDT procedure is accommodated in the HARQ buffer for the RACH based SDT procedure, the UE obtains the MAC PDU from the one or more HARQ buffers for the CG based SDT procedure, and stores the obtained MAC PDU to the HARQ buffer for the RACH based SDT procedure. Then, the UE may transit to a RRC connected state. Specifically, transiting a UE to a RRC connected state includes: the UE requests the RRC connection establishment or RRC connection resumption, and the network indicates the UE to establish or resume the RRC connection.

In a further embodiment, if the UE is capable to perform both the RACH based SDT procedure and the CG based SDT procedure and if a MAC PDU in the one or more HARQ buffers for the CG based SDT procedure is not accommodated in the HARQ buffer for the RACH based SDT procedure, the UE reassembles the MAC PDU in the one or more HARQ buffers for the CG based SDT procedure, obtains the reassembled MAC PDU from the one or more HARQ buffers for the CG based SDT procedure, and stores the obtained MAC PDU to the HARQ buffer for the RACH based SDT procedure. Then, the UE may transit to a RRC connected state.

In some embodiments, if the UE completes the RACH based SDT procedure, the UE obtains remaining segmented MAC PDU from the HARQ buffer for the RACH based SDT procedure, stores the remaining segmented MAC PDU to the one or more HARQ buffers for the CG based SDT procedure, and transmits the remaining segmented MAC PDU by a next transmission occasion for the CG based SDT procedure.

In some other embodiments, if the UE completes the RACH based SDT procedure, the UE considers the next transmission occasion for the CG based SDT procedure as an unavailable resource.

Referring back to FIG. 4, in operation 402, the UE receives configuration information regarding a time alignment timer (TAT) for the SDT procedure.

In some embodiments, the UE performs a RACH based SDT procedure, and receives a message during the RACH based SDT procedure, wherein the message includes the configuration information. The configuration information configures, to the UE, a dedicated TAT for the SDT procedure.

In some other embodiments, the UE receives a broadcast message, which includes the configuration information. The configuration information configures, to a cell, a TAT for the SDT procedure. The UE is capable of camping on the cell. In certain cases, the UE camps on the cell.

In some embodiments, the configuration information received in operation 402 includes a dedicated time length value of the TAT for the SDT procedure (e.g., a larger TAT value). The configuration information may be received through a broadcast message or through RRC signaling.

In an embodiment, if the configuration information is received through a broadcast message and if the configuration information includes a time length value of a TAT, the UE applies the time length value in the configuration information to the TAT for the SDT procedure.

In another embodiment, if the configuration information is received through RRC signaling and if the UE transits from a RRC connected state to “one of a RRC idle state and a RRC inactive state”, the UE considers the TAT for the SDT procedure as unexpired, and starts or restarts the TAT for the SDT procedure.

In some embodiments, the UE performs a RACH based SDT procedure.

Then, the UE receives, during the RACH based SDT procedure, configuration information regarding another TAT for the SDT procedure. In some cases, the UE overrides the TAT for the SDT procedure by the abovementioned another TAT for the SDT procedure. For example, if the TAT for the SDT procedure is cell-specific and the abovementioned another TAT for the SDT procedure is UE-specific, the UE may overrides the cell-specific SDT TAT by the UE-specific SDT TAT.

In some other embodiments, the UE receives, during a CG based SDT procedure or in a RRC message, configuration information regarding another TAT for the SDT procedure, and the UE may override the TAT for the SDT procedure by the abovementioned another TAT for the SDT procedure.

In an embodiment, the UE receives, from a network or a BS, enabling information to enable the UE to override the TAT for the SDT procedure by the abovementioned another TAT for the SDT procedure. In a further embodiment, the UE receives, from a network or a BS, configuration information to configure the UE to override the TAT for the SDT procedure by the abovementioned another TAT for the SDT procedure.

In some embodiments, the UE receives, a random access response message, which includes a TAC. The TAC indicates an index value. The index value is used to control an amount of timing adjustment.

In an embodiment, if a TA for the SDT procedure is maintained, the UE stores the candidate time length value. If a contention resolution is considered as successful, the UE sets the stored candidate time length value as a time length value of the TAT for the SDT procedure, and restarts the TAT for the SDT procedure. In this embodiment, the UE may re-initialize a configured counter associated with the TA and re-initialize a configured timer associated with the TA. For instance, the UE re-initializes all other configured counter(s) associated with the TA and all other configured timer(s) associated with the TA.

In a further embodiment, the UE applies the TAC to the UE, and starts or restarts the TAT for the SDT procedure, in response to one of following conditions:
a TA for the SDT procedure being not maintained;
the TA for the SDT procedure being not maintained and not successfully completing a contention resolution; and
the TA for the SDT procedure being not maintained and the TAT for the SDT procedure being running.

In this embodiment, if the contention resolution is considered as unsuccessful, the UE may stop the TAT for the SDT procedure. Then, the UE may stop a configured counter associated with the TA and stop a configured timer associated with the TA. For instance, the UE stops all other configured counter(s) associated with the TA and all other configured timer(s) associated with the TA.

In some embodiments, the UE ignores the TAC in the random access response message, in response to one of following conditions:
the TA for the SDT procedure being maintained;
the TAT for the SDT procedure being running; and
a TA for the SDT procedure being maintained and the TAT for the SDT procedure being running.

In some further embodiments, the UE monitors a physical downlink control channel (PDCCH) message. If the UE receives the PDCCH message and the PDCCH message includes timing advance adjustment, the UE may apply the timing advance adjustment, and start or restart the TAT for the SDT procedure.

In some other embodiments, the UE monitors downlink control information (DCI). The DCI is scrambled by a radio network temporary identifier (RNTI) used for the SDT procedure. For example, SDT-RNTI or cell radio network temporary identifier (C-RNTI) or UE identity is used to facilitate the RRC resume procedure, or UE identity is used to facilitate the SDT procedure. The DCI includes at least one of: an uplink grant for an uplink packet, a downlink grant for a downlink packet, and a TAC. If the UE receives the DCI and the DCI includes the TAC, the UE may apply the TAC to the UE, and start or restart the TAT for the SDT procedure.

All details described in the embodiments as illustrated and shown in FIGS. 1-3, 5, and 6, especially, contents related to specific operations for handling TA for a SDT procedure of a UE, are applicable for the embodiments as illustrated and shown in FIG. 4. Moreover, all details described in the embodiments of FIG. 4 are applicable for all the embodiments of FIGS. 1-3, 5, and 6.

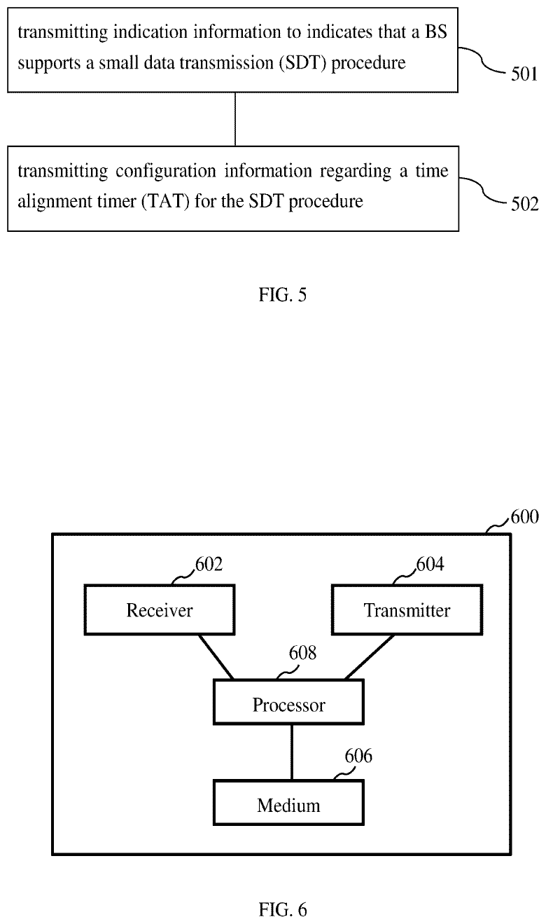

FIG. 5 is a flow diagram illustrating a method for transmitting configuration information regarding a TAT for a SDT procedure according to some embodiments of the present application.

The method illustrated in FIG. 5 may be implemented by a network or a BS (e.g., BS 102, BS 220, or BS 320 as shown and illustrated in any of FIGS. 1-3). Although described with respect to a network or a BS, it should be understood that other devices may be configured to perform a method similar to that of FIG. 5.

As shown in FIG. 5, in operation 501, a BS transmits indication information to indicate that the BS supports a SDT procedure. For example, the SDT procedure is at least one of: a RACH based SDT procedure; and a CG based SDT procedure (e.g., CG type1 based SDT procedure).

In an embodiment, the TAT for the SDT procedure is used only for the RACH based SDT procedure. In a further embodiment, the TAT for the SDT procedure is used only for the CG based SDT procedure. In another embodiment, the TAT for the SDT procedure is used for a combination of the RACH based SDT procedure and the CG based SDT procedure.

In operation 502, the BS transmits configuration information regarding a TAT for the SDT procedure. In some embodiments, the configuration information is transmitted through a broadcast message or through RRC signaling. In some embodiments, the configuration information transmitted in operation 502 includes a dedicated time length value of the TAT for the SDT procedure (e.g., a larger TAT value).

In an embodiment, the BS transmits a message during a RACH based SDT procedure of a UE (e.g., UE 101, UE 210, or UE 310 as shown and illustrated in any of FIGS. 1-3). The message includes the configuration information, and the configuration information configures, to the UE, a dedicated TAT for the SDT procedure.

In a further embodiment, the BS transmits a broadcast message including the configuration information to configure, to a cell, a TAT for the SDT procedure.

In some embodiments, the BS transmits, during a RACH based SDT procedure of a UE, configuration information regarding another TAT for the SDT procedure. In some other embodiments, the BS transmits, during a CG based SDT procedure of a UE, configuration information regarding another TAT for the SDT procedure. The TAT for the SDT procedure is configured to be allowed to be overridden by the abovementioned another TAT for the SDT procedure. For example, if the TAT for the SDT procedure is cell-specific and the abovementioned another TAT for the SDT procedure is UE-specific, the UE may overrides the cell-specific SDT TAT by the UE-specific SDT TAT.

In some embodiments, the BS transmits, a random access response message, wherein the random access response message includes a TAC. The TAC indicates an index value which is used to control an amount of timing adjustment.

In some further embodiment, the BS transmits a PDCCH message, which indicates timing advance adjustment.

In some other embodiments, the BS transmits downlink DCI. The DCI includes at least one of: an uplink grant for an uplink packet; a downlink grant for a downlink packet; and a TAC.

All details described in the embodiments as illustrated and shown in FIGS. 1-4 and 6, especially, contents related to specific operations for handling TA for a SDT procedure of a UE, are applicable for the embodiments as illustrated and shown in FIG. 5. Moreover, all details described in the embodiments of FIG. 5 are applicable for all the embodiments of FIGS. 1-4 and 6.

The following text describes detailed Examples 1-8 of the present application regarding “configuration of a SDT TAT”.

### Example 1

(1) A separate Msg3/MsgA HARQ buffer for a RACH based SDT procedure (for example, Msg3-SDT) can be specified or configured.
(2) A HARQ process associated with the separate Msg3/MsgA HARQ buffer is specified or configured.
(3) At least one TAT for SDT (e.g., one TAT is for RACH based SDT TAT and one TAT is for CG type 1 based SDT TAT) can be configured in a system broadcast message, for example, SIB1 or with the indication of supporting SDT.
(4) The at least one TAT is applied once the SDT procedure is initialized.
(5) The at least one TAT is started once a TAC is received (optionally, if the TAT is not running).
(6) The at least one TAT is restarted once a TAC MAC CE is received or a PDCCH transmission indicates timing advance adjustment.
(7) If more than one TAT are configured for SDT, at least one TAT is for RACH based SDT and at least one TAT is for CG type1 based SDT.

In some cases of Example 1, the at least one TAT for SDT can be represented by a counter. If the counter is increased to the maximum value ‘K’, it means that the TA is not valid. The counter is initialized to 0. The counter is increased each time the TAC is received or the preamble (Msg1/MsgA) is transmitted or a Msg3/MsgA PUSCH transmission is transmitted.

### Example 2

(1) A separate Msg3/MsgA HARQ buffer for RACH based SDT procedure (for example, Msg3-SDT) can be specified or configured.
(2) A HARQ process associated with the separate Msg3/MsgA HARQ buffer is specified or configured.
(3) At least one TAT for SDT (e.g., one TAT is for RACH based SDT TAT and one TAT is for CG type 1 based SDT TAT) can be configured during a RACH based SDT procedure including Msg2/MsgB/Msg4 or can be configured in RRC message. For example, the UL assistant information indicates that there are multiple UL/DL packets following the RACH based SDT procedure or the CG type1 based resources for SDT is configure during the RACH based SDT procedure. Then, a TAT for SDT can be configured in Msg4 or the TAT for SDT is configured before/in the RRCRelease message.
(4) The at least one TAT is started once it is configured.
(5) The at least one TAT is restarted once a TAC MAC CE is received or a PDCCH transmission indicates timing advance adjustment.
(6) If more than one TATs are configured for SDT, at least one TAT is for RACH based SDT and at least one TAT is for CG type 1 based SDT.

In some cases of Example 2, the at least one TAT for SDT can be represented by a counter. If the counter is increased to the maximum value ‘K’, it means the TA is not valid. The counter is initialized to 0. The counter is increased each time the TAC is received or the preamble (Msg1/MsgA)/Msg3/MsgA PUSCH is transmitted.

### Example 3

(1) One TAT for SDT is configured in the pre-configured PUSCH resource configuration.
(2) The TAT for a CG type 1 based SDT procedure can be reused to a RACH based SDT procedure.
(3) The TAT configuration should be maintained when the CG type 1 SDT configuration is released (optionally, multiple UL/DL SDT is indicated, or a RACH based SDT procedure is supported).

### Example 4

(1) At least one TAT for SDT is configured in a system broadcast message, for example, SIB1 or with an indication of supporting SDT.
(2) At least one TAT for SDT is configured during a RACH based SDT procedure including Msg2/MsgB/Msg4. Alternatively, at least one TAT for SDT is configured in RRC message.
(3) The at least one TAT for SDT configured in a system broadcast message can be overridden by a TAT for SDT configured during a RACH based SDT procedure or in RRC message.

### Example 5

(1) Both a CG type 1 based SDT procedure and a RACH based SDT procedure are configured. A UE initializes the CG type 1 based SDT procedure, and data is segmented.
(2) There is a PRACH/MsgA resources (for SDT) before the next SDT CG type 1 occasion arriving.
(3) The data in a HARQ buffer for the CG type 1 based SDT procedure should be obtained by a separate SDT Msg3/MsgA HARQ buffer for the RACH based SDT procedure, if the MAC PDU can be accommodated in the separate SDT Msg3/MsgA HARQ buffer for the RACH based SDT procedure. Otherwise, the MAC PDU in the HARQ buffer for the CG type 1 based SDT procedure should be reassembled. Or, the MsgA PUSCH resource should not be considered as an available resource.
(4) After the RACH based SDT procedure, there is still segmented data when the next SDT CG type 1 occasion arriving, the data in the separate SDT Msg3/MsgA HARQ buffer for the RACH based SDT procedure should be obtained by the HARQ buffer for the CG type 1 based SDT procedure.

Alternatively, after the RACH based SDT procedure, configuration information or a note to should be added to a specification document to state that the CG type 1 occasion should not be considered as an available resource.

### Example 6

(1) Both a CG type 1 based SDT procedure and a RACH based SDT procedure are configured. A UE initializes the CG type 1 based SDT procedure, and data is segmented.
(2) The system broadcasts that a CG type 1 based SDT procedure is not supported.
(3) The data in the HARQ buffer for the CG type 1 based SDT procedure should be obtained by a separate SDT Msg3/MsgA HARQ buffer for the RACH based SDT procedure, if the MAC PDU can be accommodated in the separate SDT Msg3/MsgA HARQ buffer for the RACH based SDT procedure. Otherwise, the MAC PDU in the HARQ buffer for the CG type 1 based SDT procedure should be reassembled according to an indication related to the separate SDT Msg3/MsgA HARQ buffer for the RACH based SDT procedure.

Alternatively, a note may be added to a specification document to specify that, for example, a UE should transit to RRC_CONNECTION state in this case or UE implementation.

### Example 7

(1) Add one or more larger values to a parameter “timeAlignmentTimerCommon”.
(2) When the one or more larger values are configured in a system broadcast message, the TAT is only applied to a SDT procedure.

### Example 8

(1) Add one or more larger values to a parameter “timeAlignmentTimer”.
(2) When the one or more larger values are configured in a RRC message or RRC signaling, the TAT is not considered as expired when a UE transits to RRC_CONNECTED state, and the TAT is started or restarted once the UE transits from RRC_CONNECTED state to RRC_IDLE or RRC_INACTIVE state.

The following text describes detailed Examples (1)-(8) of the present application regarding “Handling of TA in Msg2/MsgB”.

### Example (1)

When a TAC is received in a Random Access Response message during a SDT procedure or in a MsgB for a SDT procedure for a serving cell, the UE ignores the received TAC if the SDT TAT is running and the TA for SDT is valid.

### Example (2)

When a TAC is received in a Random Access Response message during a SDT procedure or in a MsgB for a SDT procedure for a serving cell, the UE applies the TAC and starts or restarts the SDT-timeAlignmentTimer if the TAT is running and the TA is not valid.

### Example (3)

When a TAC is received in a Random Access Response message during a SDT procedure or in a MsgB for a SDT procedure for a serving cell, the UE ignores the received TAC if the SDT TAT is running (e.g., only TAT is running is configured as the condition of TA validity).

### Example (4)

When a TAC is received in a Random Access Response message during a SDT procedure or in a MsgB for a SDT procedure for a serving cell, the UE ignores the received TAC if the TA for SDT is valid.

### Example (5)

When a TAC is received in a Random Access Response message during a SDT procedure or in a MsgB for a SDT procedure for a serving cell, the UE applies the TAC and starts or restarts the SDT-timeAlignmentTimer if the TA is not valid.

### Example (6)

(1) A TAC is received in a Random Access Response message (e.g., Msg2) for which procedure the contention resolution has not been successfully completed.
(2) The UE stores the TA value received in Msg2 if the TA for SDT is valid.
(3) The UE applies the existed SDT TA value for UL transmissions of the following RACH procedure if the TA for SDT is valid.
(4) Once the contention resolution is considered as successful, the UE sets the stored value to the TA value, and restarts the TAT, and re-initializes all the other configured TA related counter or timer.

### Example (7)

(1) A TAC is received in a Random Access Response message (e.g., Msg2) for which procedure the contention resolution has not been successfully completed.
(2) The UE applies the TAC and starts or restarts the SDT-timeAlignmentTimer if TA is not valid.
(3) Once the contention resolution is considered as not successful, the TA for SDT should be considered as invalid, and the UE stops the SDT-timeAlignmentTimer and all the other configured TA related counter or timer.
(4) Once the contention resolution is considered as successful, the TA for SDT should be considered as valid.

### Example (8)

The above procedures can be realized by a 3GPP specification document as:
when a Timing Advance Command MAC control element is received or PDCCH indicates timing advance adjustment as specified in TS 36.212 [5] during SDT (Including RACH based and CG type 1 based SDT):
   apply the Timing Advance Command or the timing advance adjustment;
   start or restart the SDT-TimeAlignmentTimer, if configured.
1> when a Timing Advance Command is received in a Random Access Response message during SDT or in a MsgB for SDT for a serving cell:
   2> if the Random Access Preamble was not selected by the MAC entity among the contention-based Random Access Preamble:
      3> apply the Timing Advance Command (optionally, for this timing advance group (TAG));
      3> start or restart the SDT-timeAlignmentTimer (optionally, associated with this TAG).
   2> else if the SDT-timeAlignmentTimer associated with this TAG is not running:
      3> apply the Timing Advance Command (optionally, for this TAG);
      3> start the SDT-timeAlignmentTimer (optionally, associated with this TAG);
      3> when the Contention Resolution is considered not successful as described in clause 5.1.5; or
      3> when the Contention Resolution is considered successful for SI request as described in clause 5.1.5, after transmitting HARQ feedback for MAC PDU including UE Contention Resolution Identity MAC CE:
         4> stop SDT-timeAlignmentTimer associated with this TAG.
   2> else if the SDT-timeAlignmentTimer (optionally, associated with this TAG) is running and the CG type 1 for SDT is not available:
      3> apply the Timing Advance Command (optionally, for this TAG);
      3> start or restart the SDT-timeAlignmentTimer (optionally, associated with this TAG).
   2> else:
      3> ignore the received Timing Advance Command.

The following text describes detailed Examples A and B of the present application regarding “Behavior when SDT TAT is configured”.

### Example A

(1) A UE should monitor related DCI to receive UL grant or DL grant for following UL and/or DL packets. For example, a UE monitors DCI 0_0 and/or DCO 1_0 when the UE is in a RRC_INACTIVE state and performs a SDT procedure.
(2) In this case, the SDT TAT could be running or not running if it is configured.
(3) If the SDT TAT expires and the TAC is received in the DCI, the UE applies the TAC, and starts or restarts the SDT TAT.

### Example B

The above procedures can be realized by a 3GPP specification document as:
DCI format 0_0 is used for the scheduling of PUSCH in one cell.
The following information is transmitted by means of the DCI format 0_0 with CRC scrambled by C-RNTI or CS-RNTI or MCS-C-RNTI or SDT-RNTI:

The following text describes detailed Examples (a) and (b) of the present application regarding “TA validation criteria”.

### Example (a)

(1) A UE considers the TA as valid within its corresponding TAG.
(2) The UE can continuously transmit or receive data when the UE moves from a cell to a neighbor cell if both of the cells belong to the same TAG.
(3) Further, the cells can be more than two cells.
(4) Further, all of the cells are configured with pre-configured PUSCH resources.
(5) Further, all of the cells are configured with pre-configured PUSCH resources and/or dedicated resources for a RACH based SDT procedure.
(6) Further, if the CG type 1 resources in the serving cell and neighbor cell and/or the integrity and key related parameters of the serving cell and neighbor cell are pre-configured, the UE can retransmit unacknowledged PDCP service data unit (SDU) or PDU in the neighbor cell.

### Example (b)

The segmented packets can be continued to transmit as a part of the same SDT mechanism and without transitioning the UE to a RRC_CONNECTED state, when at least the following conditions is fulfilled:
   1> the UE has a valid timing alignment value; and
   2> SDT-TimeAlignmentTimer is running (optionally, as confirmed by lower layers).

Before the above procedure in Example (b), the SDT can be initialized, when at least the following condition is fulfilled:
If the size of a packet from a higher layer is larger than the transport block size (TBS) threshold of the UL SDT, the packet can be segmented.

In Example (b), a packet from a higher layer can be segmented, when at least the following condition is fulfilled:
The related quality of service (QoS) requirements (for example, delay or packet delay budget (PDB)) and data rate can be satisfied.

Further, in Example (b), whether the segmentation for a DRB when doing SDT is allowed can be configured by the network. Alternatively, the UE decides, for example, according to the CG type 1 period and modulation and coding scheme (MCS) comparing with the PDB.

FIG. 6 illustrates an exemplary block diagram of an apparatus according to some embodiments of the present application. In some embodiments of the present application, the apparatus 600 may be a UE, which can at least perform the method illustrated in FIG. 4. In some embodiments of the present application, the apparatus 600 may be a BS, which can at least perform the method illustrated in FIG. 5.

As shown in FIG. 6, the apparatus 600 may include at least one receiver 602, at least one transmitter 604, at least one non-transitory computer-readable medium 606, and at least one processor 608 coupled to the at least one receiver 602, the at least one transmitter 604, and the at least one non-transitory computer-readable medium 606.

Although in FIG. 6, elements such as the at least one receiver 602, the at least one transmitter 604, the at least one non-transitory computer-readable medium 606, and the at least one processor 608 are described in the singular, the plural is contemplated unless limitation to the singular is explicitly stated. In some embodiments of the present application, the at least one receiver 602 and the at least one transmitter 604 are combined into a single device, such as a transceiver. In certain embodiments of the present application, the apparatus 600 may further include an input device, a memory, and/or other components.

In some embodiments of the present application, the at least one non-transitory computer-readable medium 606 may have stored thereon computer-executable instructions which are programmed to implement the operations of the methods, for example as described in view of any of FIGS. 4 and 5, with the at least one receiver 602, the at least one transmitter 604, and the at least one processor 608.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

What is claimed is:

1. An apparatus, comprising:
a memory; and
a processor coupled to the memory, the processor configured to cause the apparatus to:
receive, by a user equipment (UE), indication information, wherein the indication information indicates that a base station (BS) supports a small data transmission (SDT) procedure, and wherein the UE is capable to perform the SDT procedure; and
receive configuration information regarding a time alignment timer (TAT) for the SDT procedure.

2. The apparatus of claim 1, wherein the UE is configured with at least one of:
one or more first hybrid automatic repeat request (HARQ) buffers for a configured grant (CG) based SDT procedure; or
a second HARQ buffer for a random access channel (RACH) based SDT procedure.

3. (canceled)

4. The apparatus of claim 1, wherein the configuration information includes a dedicated time length value of the TAT for the SDT procedure.

5. The apparatus of claim 1, wherein the configuration information is received through a broadcast message or through radio resource control (RRC) signaling.

6. The apparatus of claim 5, further comprising, in response to the configuration information being received through the broadcast message:
in response to the configuration information including a time length value of a TAT, the processor is configured to cause the apparatus to apply the time length value to the TAT for the SDT procedure.

7. The apparatus of claim 5, further comprising, in response to the configuration information being received through the RRC signaling, the processor is configured to cause the apparatus to:
in response to the UE transiting from a RRC connected state to a RRC idle state or in response to the UE transiting from the RRC connected state to a RRC inactive state:
consider the TAT for the SDT procedure as unexpired; and
start or restart the TAT for the SDT procedure.

8. The apparatus of claim 1, wherein to receive the configuration information the processor is configured to cause the apparatus to:
perform a random access channel (RACH) based SDT procedure; and
receive a message during the RACH based SDT procedure, wherein the message includes the configuration information, and wherein the configuration information configures, to the UE, a dedicated TAT for the SDT procedure.

9. The apparatus of claim 1, wherein to receive the configuration information the processor is configured to cause the apparatus to:
receive a broadcast message, wherein the broadcast message includes the configuration information, wherein the configuration information configures, to a cell, a TAT for the SDT procedure, and wherein the UE is capable of camping on the cell.

10. The apparatus of claim 1, wherein the processor is configured to cause the apparatus to:
perform a random access channel (RACH) based SDT procedure;
receive, during the RACH based SDT procedure, second configuration information regarding a second TAT for the SDT procedure; and
override the TAT for the SDT procedure by the second TAT for the SDT procedure.

11. The apparatus of claim 1, wherein the processor is configured to cause the apparatus to:
receive, during one or more of a configured grant (CG) based SDT procedure or in a radio resource control (RRC) message, second configuration information regarding a second TAT for the SDT procedure; and
override the TAT for the SDT procedure by the second TAT for the SDT procedure.

12. The apparatus of claim 1, wherein the processor is configured to cause the apparatus to:
receive a random access response message, wherein the random access response message includes a timing advance command (TAC), wherein the TAC indicates an index value, and wherein the index value is used to control an amount of timing adjustment.

13. The apparatus of claim 12, wherein the processor is configured to cause the apparatus to:
ignore the TAC in the random access response message, in response to one or more of:
the TAT for the SDT procedure being maintained;
the TAT for the SDT procedure being running; or
a TAT for the SDT procedure being maintained and the TAT for the SDT procedure being running.

14. The apparatus of claim 1, wherein the processor is configured to cause the apparatus to:
monitor downlink control information (DCI), wherein the DCI is scrambled by a radio network temporary identifier (RNTI) used for the SDT procedure, and wherein the DCI includes at least one of: an uplink grant for an uplink packet, a downlink grant for a downlink packet, or a timing advance command (TAC); and
in response to receiving the DCI and in response to the DCI including the TAC:
apply the TAC to the UE; and
start or restart the TAT.

15. (canceled)

16. The apparatus of claim 1, wherein the processor is configured to cause the apparatus to:
determine that one or more of a timing advance command (TAC) is received or physical downlink control channel (PDCCH) indicates a timing advance adjustment during the SDT procedure; and
perform one or more of to:
apply one or more of the TAC or the timing advance adjustment; and
start or restart the TAT for the SDT procedure.

17. The apparatus of claim 14, wherein the TAT is for a timing advance group (TAG) or associated with a TAG.

18. An apparatus, comprising:
a memory; and
a processor coupled to the memory, the processor configured to cause the apparatus to:
transmit, to a user equipment (UE), indication information to indicate that a base station (BS) supports a small data transmission (SDT) procedure; and
transmit, to the UE, configuration information regarding a time alignment timer (TAT) for the SDT procedure.

19. The apparatus of claim 18, wherein the SDT procedure comprises at least one of a random access channel (RACH) based SDT procedure or a configured grant (CG) based SDT procedure.

20. The apparatus of claim 19, wherein the TAT is configured to be used for one or more of:
the RACH based SDT procedure;
the CG based SDT; or
a combination of the RACH based SDT procedure and the CG based SDT procedure.

21. The apparatus of claim 18, wherein the processor is configured to transmit the configuration information via one or more of a broadcast message or radio resource control (RRC) signaling.

22. A method, comprising:
receiving, by a user equipment (UE), indication information, wherein the indication information indicates that a base station (BS) supports a small data transmission (SDT) procedure, and wherein the UE is capable to perform the SDT procedure; and
receiving configuration information regarding a time alignment timer (TAT) for the SDT procedure.
